(19) United States
(12) Patent Application Publication
(10) Pub. No.: US 2014/0258901 A1
(43) Pub. Date: Sep. 11, 2014

(54) APPARATUS AND METHOD FOR DELETING AN ITEM ON A TOUCH SCREEN DISPLAY

(71) Applicant: SAMSUNG ELECTRONICS CO., LTD., GYEONGGI-DO (KR)

(72) Inventor: Xae-Min CHO, Gyeonggi-do (KR)

(73) Assignee: SAMSUNG ELECTRONICS CO., LTD., GYEONGGI-DO (KR)

(21) Appl. No.: 14/204,396

(22) Filed: Mar. 11, 2014

(30) Foreign Application Priority Data
Mar. 11, 2013 (KR) 10-2013-0025721

(51) Int. Cl. G06F 3/0488; G06F 3/0484; G06F 3/0481

(52) U.S. Cl. CPC G06F 3/04883; G06F 3/04817; G06F 3/04842
USPC 715/765

(57) ABSTRACT

An apparatus and method are provided for deleting an item displayed on a touch screen display. The method includes recognizing a drag touch on the item displayed on the touch screen display, determining whether a pattern of the drag touch satisfies a first deletion condition, determining whether a second deletion condition associated with a user input on the touch screen display is satisfied, if the first deletion condition is satisfied, and deleting the item from the touch screen display, if the second deletion condition is satisfied.

### PRIORITY

This application claims priority under 35 U.S.C. §119(a) to Korean Patent Application Serial No. 10-2013-0025721, which was filed in the Korean Intellectual Property Office on Mar. 11, 2013, the entire disclosure of which is hereby incorporated by reference.

### BACKGROUND OF THE INVENTION

1. Field of the Invention

The present invention relates generally to a touch screen display, and more particularly, to a method and apparatus for deleting an item displayed on a touch screen display.

2. Description of the Related Art

In a conventional portable terminal, to delete an item or an application, an environment setting menu and an application management menu are sequentially executed and a corresponding application installed in the portable terminal is deleted in the application management menu.

Additionally, a user may delete an icon by pressing the icon displayed on the touch screen display for a predetermined duration and then performing a subsequent action. However, even with these multiple step deletion processes, icons, items, or applications are still inadvertently deleted. Accordingly, a need exists for a method for providing an intuitive User Experience (UX) to a user, which prevents unwanted deletion of applications by mistake.

### SUMMARY OF THE INVENTION

The present invention has been made to at least partially solve, alleviate, or remove at least one of problems and/or disadvantages described above.

Accordingly, an aspect of the present invention is to provide a method for providing an intuitive UX to a user, which prevents unintended deletion of an application.

In accordance with an aspect of the present invention, a method is provided for deleting an item displayed on a touch screen display. The method includes recognizing a drag touch on the item on the touch screen display, determining whether a pattern of the drag touch satisfies a first deletion condition, determining whether a second deletion condition associated with a user input on the touch screen display is satisfied, if the first deletion condition is satisfied, and deleting the item from the touch screen display, if the second deletion condition is satisfied.

In accordance with another aspect of the present invention, a portable terminal is provided. The portable terminal includes a touch screen display for displaying an item thereon, and a controller for recognizing a drag touch on the item on the touch screen display, determining whether a pattern of the drag touch satisfies a first deletion condition, determining whether a second deletion condition associated with a user input on the touch screen display is satisfied, if the first deletion condition is satisfied, and deleting the item from the touch screen display, if the second deletion condition is satisfied.

### BRIEF DESCRIPTION OF THE DRAWINGS

The above and other aspect, features, and advantages of certain embodiments of the present invention will be more apparent from the following detailed description, taken in conjunction with the accompanying drawings, in which:

FIG. 1 is a schematic block diagram illustrating a portable terminal according to an embodiment of the present invention;

FIG. 2 illustrates a front perspective view of a portable terminal according to an embodiment of the present invention;

FIG. 3 illustrates a rear perspective view of a portable terminal according to an embodiment of the present invention;

FIG. 4 illustrates a touch screen according to an embodiment of the present invention;

FIG. 5 illustrates an input tool according to an embodiment of the present invention;

FIG. 6 is a flowchart illustrating a method for deleting an item according to an embodiment of the present invention;

FIGS. 7A through 8C illustrate a method for deleting an item according to an embodiment of the present invention;

FIGS. 9A through 9C illustrate different first deletion conditions according to embodiments of the present invention;

FIGS. 10A and 10B illustrate example of different methods for simultaneously deleting a plurality of items according to embodiments of the present invention;

FIGS. 11A through 10C illustrate a method for deleting an item according to an embodiment of the present invention;

FIGS. 12A through 12C illustrate different visual effects according to embodiments of the present invention; and

FIGS. 13A through 13C illustrate a method for deleting an item according to an embodiment of the present invention.

Throughout the drawings, like reference numerals will be understood to refer to like parts, components, and structures.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Herein, a terminal may be referred to as a portable terminal, a mobile terminal, a communication terminal, a portable communication terminal, or a portable mobile terminal. For example, the terminal may be a smart phone, a cellular phone, a game console, a Television (TV), a display, a vehicle head unit, a notebook computer, a laptop computer, a tablet computer, a Personal Media Player (PMP), a Personal Digital Assistant (PDA), etc. The terminal may be implemented with a pocket-size portable communication terminal having a wireless communication function. The terminal may be a flexible device or a flexible display.

Herein, the terminal is described as a cellular phone, and some components herein may be omitted or changed from the representative structure of the terminal.

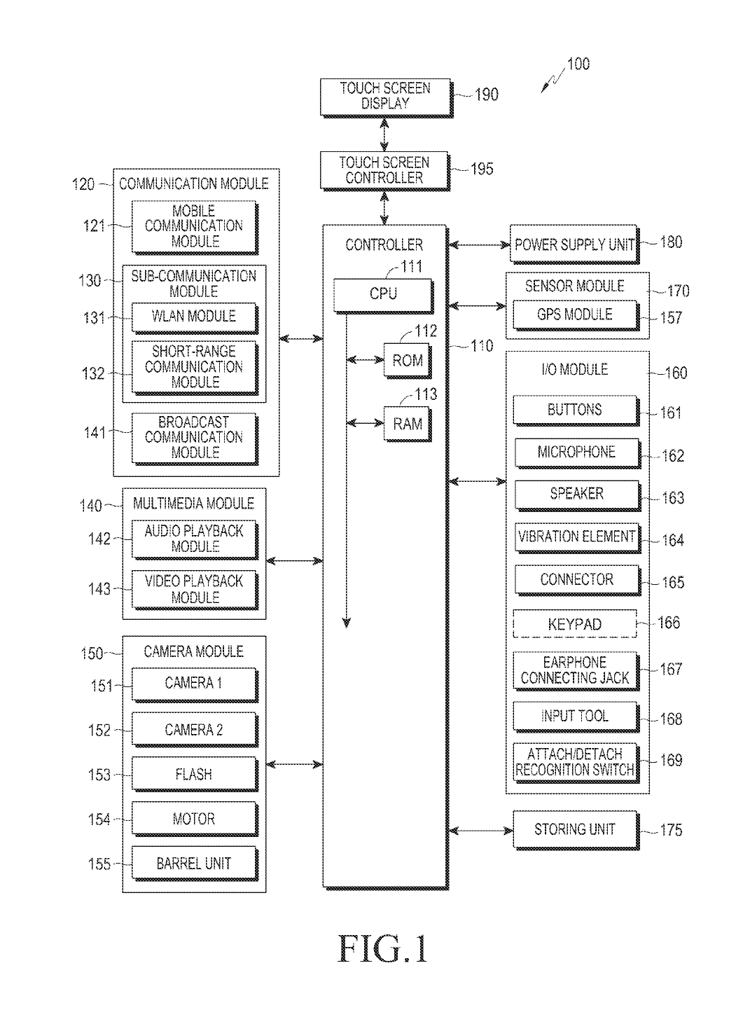

FIG. 1 is a schematic block diagram illustrating a portable terminal according to an embodiment of the present invention.

Referring to FIG. 1, a portable terminal 100 includes a communication module 120, a connector 165, and an earphone connecting jack 167. The portable terminal 100 also includes a touch screen display 190, a touch screen controller 195, a controller 110, a multimedia module 140, a camera module 150, an input/output module 160, a sensor module 170, a storing unit 175, and a power supply unit 180.

The communication module 120 includes a mobile communication module 121, a sub communication module 130, and a broadcast communication module 141.

The sub communication module 130 includes a Wireless Local Area Network (WLAN) module 131 and a short-range communication module 132.

The multimedia module 140 includes an audio playback module 142 and a video playback module 143.

The camera module 150 includes a first camera 151, a second camera 152, a barrel unit 155 for zoom-in/zoom-out operations of the first camera 151 and the second camera 152, a motor 154 for controlling zoom-in/zoom-out motion of the barrel unit, and a flash 153 for providing a light source for photographing.

The controller 110 includes a Read Only Memory (ROM) 112 in which a control program for controlling the portable terminal 100 is stored, and a Random Access Memory (RAM) 113, which memorizes a signal or data input from the portable terminal 100 or is used as a memory region for a task performed in the portable terminal 100. A Central Processing Unit (CPU) 111 may include a single core, a dual core, a triple core, or a quad core processor. The CPU 111, the ROM 112, and the RAM 113 may be interconnected through an internal bus.

The controller 110 controls the communication module 120, the multimedia module 140, the camera module 150, the input/output module 160, the sensor module 170, the storing unit 175, the power supply unit 180, the touch screen display 190, and the touch screen controller 195. Further, the controller 110 senses a user input generated when a user input tool 168, the user's finger, etc. touches one of a plurality of objects or items displayed on the touch screen display 190, approaches the object, or is disposed in proximity to the object. The controller 110 also identifies the object corresponding to the position on the touch screen display 190 at which the user input is sensed. The user input generated through the touch screen display 190 includes a direct touch input for directly touching an object and a hovering input, which is an indirect touch input. For example, when the input tool 168 is positioned within a predetermined distance to the touch screen display 190, an object positioned immediately under the input tool 168 may be selected. In accordance with an embodiment of the present invention, the user input may further include a gesture input generated through the camera module 150, a switch/button input generated through the a button 161 or a keypad 166, and a voice input generated through a microphone 162.

The object or item (or a function item) is displayed on the touch screen display 190 of the portable terminal 100, and may be, for example, an application, a menu, a document, a widget, a picture, a moving image, an e-mail, an SMS message, and an MMS message. The object may be selected, executed, deleted, cancelled, stored, and changed. The item may be used as a concept including a button, an icon (or a shortcut icon), a thumbnail image, and a folder including at least one object in the portable terminal 100. The item may be presented in the form of an image, a text, etc.

Upon generation of a user input event with respect to a preset item or in a preset manner, the controller 110 performs a preset program operation corresponding to the generated user input event. For example, the controller 110 may output a control signal to the input tool 168 or the vibration element 164. The control signal may include information about a vibration pattern. Either the input tool 168 or the vibration element 164 generates a vibration corresponding to the vibration pattern. The information about the vibration pattern may indicate either the vibration pattern or an identifier corresponding to the vibration pattern. The control signal may include a vibration generation request alone.

A speaker 163 outputs sound corresponding to various signals or data (for example, wireless data, broadcast data, digital audio data, digital video data, or the like) under control of the controller 110. The speaker 163 may output sound corresponding to a function executed by the portable terminal 100 (e.g., button manipulation sound corresponding to a phone call, a ring back tone, or voice of a counterpart user). One or more speakers 163 may be formed in a proper position or proper positions of the housing of the portable terminal 100.

The input tool 168 may be inserted into the body of the portable terminal 100 for safe keeping, and when being used, is withdrawn or separated from the portable terminal 100. An attach/detach recognition switch 169 provides a signal corresponding to attachment or detachment of the input tool 168 to the controller 110.

The sensor module 170 includes a Global Positioning System (GPS) module 157, which receives electric waves from a plurality of GPS satellites, and calculates a location of the portable terminal 100.

The storing unit 175 stores a signal or data that is input/output corresponding to operations of the communication module 120, the multimedia module 140, the input/output module 160, the sensor module 170, or the touch screen display 190, under control of the controller 110. The storing unit 175 may also store a control program and applications for control of the portable terminal 100 and/or the controller 110.

Herein, the term “storing unit” may include the storing unit 175, the ROM 112 and the RAM 113 in the controller 110, or a memory card (not illustrated) mounted in the portable terminal 100 (for example, a Secure Digital (SD) card, a memory stick). The storing unit 175 may include a non-volatile memory, a volatile memory, a Hard Disk Drive (HDD), or a Solid State Drive (SSD).

The storing unit 175 may also store applications of various functions such as navigation, video communication, games, an alarm application based on time, images for providing a Graphic User Interface (GUI) related to the applications, user information, documents, databases or data related to a method for processing touch inputs, background images (for example, a menu screen, a standby screen, etc.), operation programs for driving the portable terminal 100, and images captured by the camera module 150. The storing unit 175 is a machine, such as, for example, a non-transitory computer-readable medium. The term “machine-readable medium” includes a medium for providing data to the machine to allow the machine to execute a particular function. The storing unit 175 may include non-volatile media or volatile media.

The machine-readable medium may include, but is not limited to, at least one of a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), and a flash EPROM.

The touch screen display 190 provides a user graphic interface corresponding to various services (for example, call, data transmission, broadcasting, picture taking) to users.

The touch screen display 190 outputs an analog signal, which corresponds to an input, to the touch screen controller 195.

As described above, a touch input to the touch screen display 190 may includes a direct contact between the touch screen display 190 and a finger or the input tool 168, or an indirect input, i.e., a detected hovering.

The touch screen controller 195 converts an analog signal received from the touch screen display 190 into a digital signal and transmits the digital signal to the controller 110. The controller 110 controls the touch screen display 190 by using the digital signal received from the touch screen controller 195. For example, the controller 110 may control a shortcut icon (not illustrated) displayed on the touch screen display 190 to be selected or executed in response to a direct touch event or a hovering event. Alternatively, the touch screen controller 195 may be included in the controller 110.

The touch screen controller 195, by detecting a value (for example, an electric-current value) output through the touch screen display 190, recognizes a hovering interval or distance as well as a user input position and converts the recognized distance into a digital signal (for example, a Z coordinate), which it sends to the controller 110. The touch screen controller 195 may also, by detecting the value output through the touch screen display 190, detect a pressure applied by the user input means to the touch screen display 190, convert the detected pressure into a digital signal, and provide the digital signal to the controller 110.

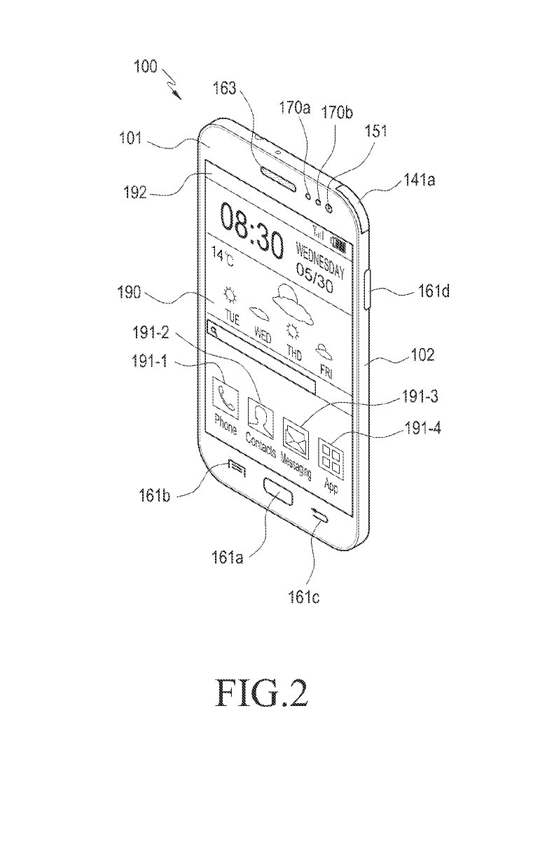

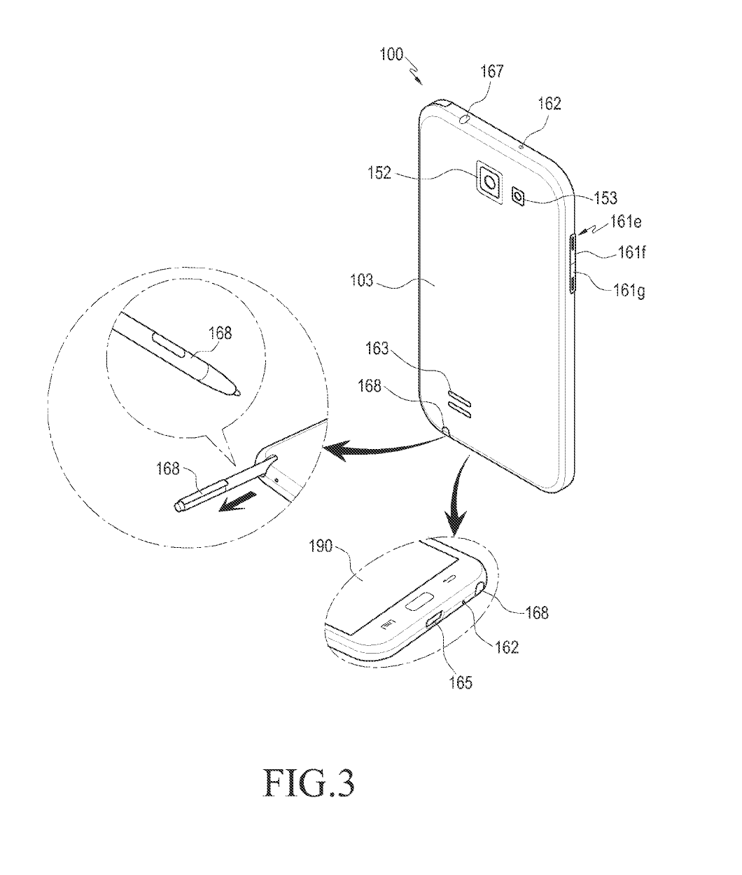

FIG. 2 illustrates a front perspective view of a portable terminal according to an embodiment of the present invention, and FIG. 3 illustrates a rear perspective view of a portable terminal according to an embodiment of the present invention.

Referring to FIGS. 2 and 3, the touch screen display 190 is disposed in the center of a front surface 101 of the portable terminal 100. Specifically, FIG. 2 illustrates an example in which a main home screen is displayed on the touch screen display 190. Shortcut icons 191-1, 191-2, and 191-3 for executing frequently used applications, a main menu change key 191-4, time, weather, etc., are also displayed on the home screen. A status bar 192 indicating a state of the portable terminal 100, such as a battery charge state, a strength of a received signal, and a current time, is displayed in an upper portion of the touch screen display 190.

A home button 161a, a menu button 161b, and a back button 161c are disposed in a lower portion of the touch screen display 190. The first camera 151, an illumination sensor 170a, and a proximity sensor 170b are disposed on an edge of the front surface 101. The second camera 152, the flash 153, and the speaker 163 are disposed on a rear surface 103.

A power/lock button 161d, a volume button 161e including a volume-up button 161f and a volume-down button 161g, a terrestrial DMB antenna 141a for broadcasting reception, and one or more microphones 162 are disposed on a lateral surface 102 of the portable terminal 102. The DMB antenna 141a may be fixed to or removable from the portable terminal 100.

The connector 165, in which multiple electrodes are formed and may be connected with an external device in a wired manner, is formed in a lower-end lateral surface of the portable terminal 100. The earphone connecting jack 167, into which the earphone may be inserted, is formed in an upper-end lateral surface of the portable terminal 100.

The input tool 168 is stored by being inserted into the portable terminal 100 and is withdrawn and separated from the portable terminal 100 for use.

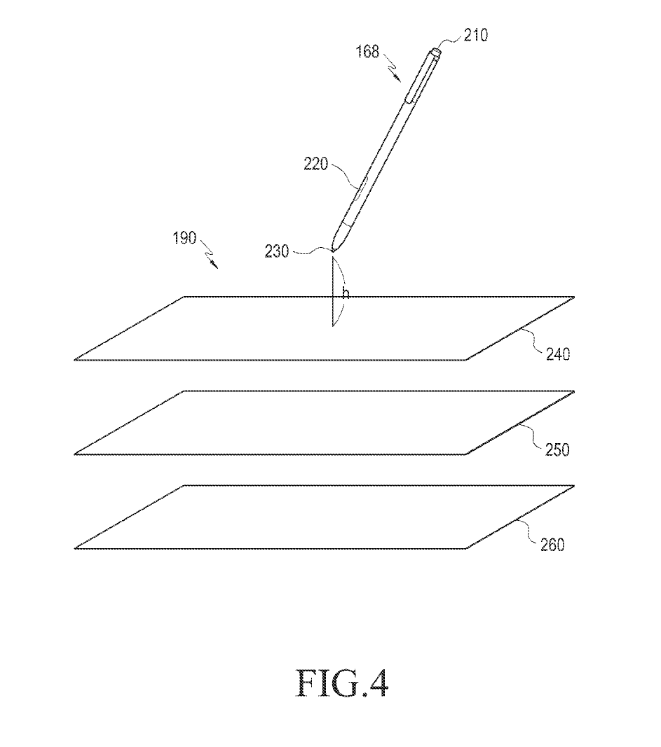

FIG. 4 illustrates a touch screen display according to an embodiment of the present invention.

Referring to FIG. 4, the touch screen display 190 includes a first touch panel 240 for sensing a finger input, a display panel 250 for screen display, and a second touch panel 260 for sensing an input from the input tool 168. The first touch panel 240, the display panel 250, and the second touch panel 260 are sequentially stacked from top to bottom by being closely adhered to one another or partially spaced apart from one another. The first touch panel 240 may also be disposed under the display panel 250.

The display panel 250 includes multiple pixels and displays an image through these pixels. For the display panel 250, a Liquid Crystal Display (LCD), an Organic Light Emitting Diode (OLED), or an LED may be used. The display panel 250 displays various operation states of the portable terminal 100, various images corresponding to execution of applications or services, and a plurality of objects.

The first touch panel 240 may include a window exposed on the front surface of the portable terminal 100 and a sensor layer attached to a bottom surface of the window to recognize information (for example, position, strength, etc.) of the finger input. The sensor layer forms a sensor for recognizing a position of a finger contact on the surface of the window, and to this end, the sensor layer has preset patterns. The sensor layer may have various patterns such as, for example, a linear latticed pattern, a diamond-shape pattern, etc. To perform a sensor function, a scan signal having a preset waveform is applied to the sensor layer, and if the finger contacts the surface of the window, a sensing signal whose waveform is changed by a capacitance between the sensor layer and the finger is generated. The controller 110 analyzes the sensing signal, thereby recognizing whether and where the finger contacts the surface of the window.

In accordance with another embodiment of the invention, the first touch panel 240 may be a panel which is manufactured by coating a thin metallic conductive material (e.g., an Indium Tin Oxide (ITO) layer) onto both surfaces of the window to allow electric current to flow on the surface of the window, and coating a dielectric, which is capable of storing electric charges, onto the coated surfaces. Once the user's finger touches a surface of the first touch panel 240, a predetermined amount of electric charge moves to the touched position by static electricity, and the first touch panel 240 recognizes the amount of change of current corresponding to movement of the electric charge, thereby sensing the touched position.

Any type of touches capable of generating static electricity may be sensed through the first touch panel 240.

The second touch panel 260 is a touch panel of an Electromagnetic Resonance (EMR), and may include an electronic induction coil sensor having a grid structure in which a plurality of loop coils intersect one another and an electronic signal processor for sequentially providing an alternating current signal having a predetermined frequency to the respective loop coils of the electronic induction coil sensor. If the input tool 168 having a resonance circuit embedded therein is brought near the loop coil of the second touch panel 260, a signal transmitted from the loop coil generates electric current based on mutual electromagnetic induction in the resonance circuit of the input tool 168. Based on the electric current, the resonance circuit of the input tool 168 generates and outputs an induction signal.

The second touch panel 260 detects the induction signal by using the loop coil, thereby sensing an input position (i.e., a hovering input position or a direct touch position) of the input tool 168. The second touch panel 260 may also sense a height “h” from the surface of the touch screen display 190 to a pen point 230 of the input tool 168. The induction signal output from the input tool 168 may have a frequency which varies according to a pressure applied by the pen point 230 of the input tool 168 to the surface of the touch screen display 190. Based on the frequency, the pressure of the input tool 168 may be sensed. Likewise, the second touch panel 260 senses a height from the surface of the touch screen display 190 to an eraser 210 of the input tool 168, based on a strength of the induction signal. The induction signal output from the input tool 168 may have a frequency which varies according to a pressure applied by the eraser 210 of the input tool 168 to the surface of the touch screen display 190. Based on the frequency, the pressure of the input tool 168 may be sensed.

An input tool 168 capable of generating electric current based on electromagnetic induction may also be sensed through the second touch panel 260.

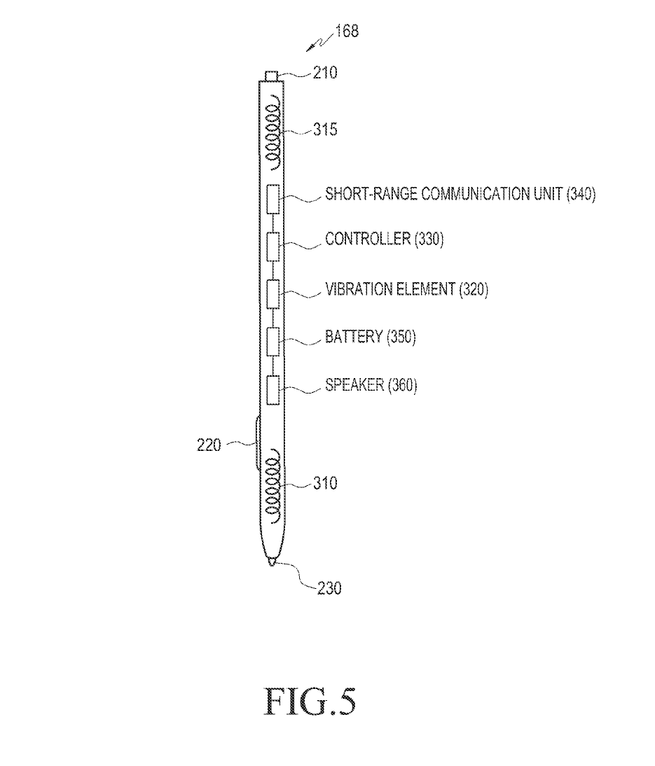

FIG. 5 illustrates an input tool according to an embodiment of the present invention.

Referring to FIG. 5, an input tool 168 includes a pen point 230, a first coil 310, an eraser 210, a second coil 315, a button 220, a vibration element 320, a controller 330, a short-range communication unit 340, a battery 350, and a speaker 360.

The first coil 310 is positioned in a region adjacent to the pen point 230 inside the input tool 168 and outputs a first induction signal corresponding to the input tool 168 input.

The second coil 315 is positioned in a region adjacent to the eraser 210 inside the input tool 168 and outputs a second induction signal corresponding to an eraser input.

The button 220 changes an electromagnetic induction value generated by the first coil 310, i.e., upon the pressing of the button 220.

The controller 330 analyzes a control signal received from the portable terminal 100, and controls vibration strength and/or vibration interval of the vibration element 320.

The short-range communication unit 340 performs short-range communication with the portable terminal 100, and the battery 350 supplies power for vibration of the input tool 168.

The speaker 360 outputs sound corresponding to vibration interval and/or vibration strength of the input tool 168. For example, the speaker 360 outputs sounds corresponding to various signals of the mobile communication module 120, the sub communication module 130, or the multimedia module 140 provided in the portable terminal 100 under control of the controller 330. The speaker 360 may also output sounds corresponding to functions executed by the portable terminal 100.

When the pen point 230 or the eraser 210 contacts the touch screen display 190 or is placed in a position in which hovering may be sensed, e.g., within 3 cm, then the controller 330 analyzes a control signal received from the portable terminal 100 through the short-range communication unit 340 and controls the vibration interval and strength of the vibration element 320 according to the analyzed control signals.

The control signal is transmitted by the portable terminal 100 and may be transmitted to the input tool 168 repetitively at predetermined intervals, e.g., every 5 ms. That is, when the pen point 230 or the eraser 210 contacts the touch screen display 190, then the portable terminal 100 recognizes a touch or hovering position on the touch screen display 190 and performs a program operation corresponding to a pen input or an eraser input. The frequency or data pattern of the first induction signal output from the first coil 310 is different from that of the second induction signal output from the second coil 315, and based on such a difference, the controller 330 distinguishes and recognizes a pen input and an eraser input.

The input tool 168 also supports an electrostatic induction scheme. Specifically, if a magnetic field is formed in a predetermined position of the touch screen display 190 by the coils 310 and 315, the touch screen display 190 detects a corresponding magnetic field position and recognizes a touch position. If the pen point 230 or the eraser 210 is adjacent to or touches the touch screen display 190, resulting in a user input event, the portable terminal 100 identifies an object corresponding to a user input position and transmits a control signal indicating a vibration pattern to the input tool 168.

In accordance with an embodiment of the present invention, a method is provided for deleting an item selected by a user. For example, an item eraser command may be implemented with a selection by the eraser 210 or an input of a preset touch pattern by the eraser 210 or the pen point 230.

Herein, deletion of an item refers to deletion of an item displayed on the touch screen display 190, and may also include the deletion of item related data stored in the storing unit 175.

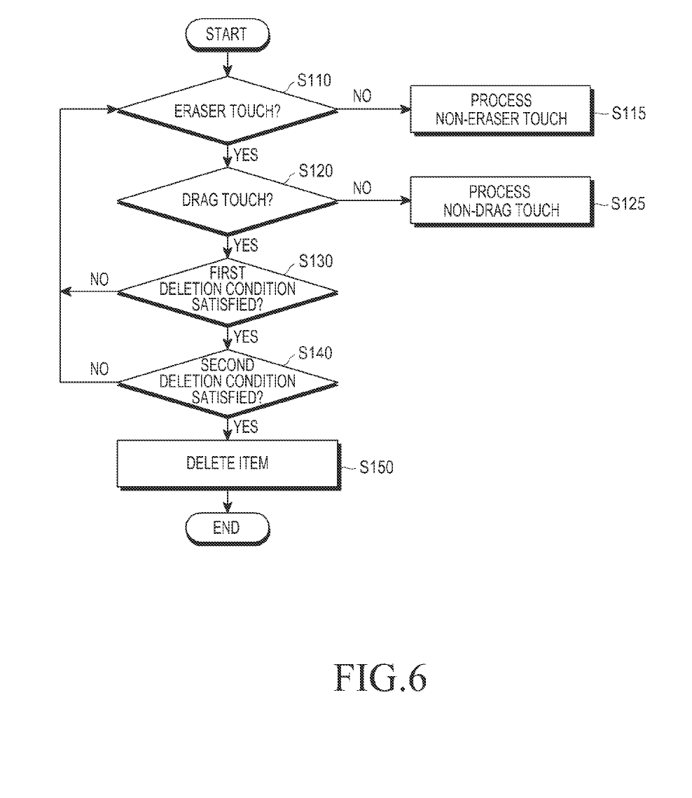

FIG. 6 is a flowchart illustrating a method for deleting an item according to an embodiment of the present invention.

Referring to FIG. 6, in step S110, the controller 110 recognizes a user touch for on an item displayed on the touch screen display 190 and determines whether the user touch is an eraser touch or a non-eraser touch (e.g., a finger touch). That is, the controller 110 determines whether or not the user touch is entered using the eraser 210 of the input tool 168.

When the touch is identified as the non-eraser touch, in step S115, the controller 110 performs selection, execution, storage, or change of an item according to at least one of a position of the non-eraser touch, a touch type (e.g., a single touch (i.e., a click or a tap), double touches, a multi-point touch, a drag touch, hovering, etc.), and a touch pattern.

However, when the touch is identified as the eraser touch, in step S120, the controller 110 determines whether the eraser touch is a drag touch or a non-drag touch. For example, a non-drag touch may include a single touch, a double touch, a multi-point touch, or hovering. Further, the drag touch occurs when the user moves the eraser 210 while contacting the touch screen display 190. The drag touch may be referred to a swipe touch or a sliding touch.

Herein, the end of the drag touch occurs at the stopping of the movement of the eraser 210 or at the removing of the eraser 210 from the touch screen display 190.

Upon recognition of the drag touch in step S120, the controller 110 recognizes a drag trajectory of the eraser 210, and continuously determines whether the drag touch is ended, while continuously storing a touch position. That is, the controller 110 stores the touch position or coordinates while continuously tracing the touch position during the drag of the eraser 210, and continuously determines whether the drag touch is ended.

When the controller 110 determines that the eraser touch is the non-drag touch, in step S125, the controller 110 performs selection, execution, storage, or change of an item according to at least one of a position of the non-drag touch, a touch type, and a touch pattern.

However, when the controller 110 determines that the eraser touch is the drag touch, in step S130, the controller 110 determines whether a pattern of the drag touch satisfies a first deletion condition, which is previously stored in the storing unit 175. For example, the first deletion condition includes at least one of a condition that the drag trajectory indicating the drag pattern should be included in the item or pass through the item (i.e., the drag trajectory should at least partially overlap the item); a condition that the drag trajectory should enclose the item; a condition that the drag trajectory should have a preset number or more of inflections; a condition that the drag trajectory should have a preset number or more of intersections; and a condition that the eraser 210 should erase the item at a preset rate or more. When the drag trajectory is included in the item, passes through the item, or encloses the item, the item may be expressed as an item display region on the touch screen display 190.

When the controller 110 determines that the drag pattern satisfies the first deletion condition, in step S140, the controller 110 determines whether a second deletion condition, which is previously stored in the storing unit 175, is satisfied. The second deletion condition is associated with an additional user input (for example, a second touch by the input tool 168), after the end of the drag touch.

For example, the second deletion condition includes at least one of a condition that no restoration (or deletion cancellation) command is input from the user for a preset time after the end of the drag touch; and a condition that the user should approve deletion after the end of the drag touch. The condition that no restoration (or deletion cancellation) command is input from the user for a preset time after the end of the drag touch includes at least one of a condition that the user should not touch the touch screen display 190 or the item before expiration of a timer after the end of the drag touch; and a condition that the user should maintains a touch on the touch screen display 190 or the item until expiration of the timer, even after the end of the drag touch.

When the controller 110 determines that the drag pattern does not satisfy either the first deletion condition or the second deletion condition, the process returns to step S110.

When the controller 110 determines that the user input satisfies the second deletion condition, in step S150, the controller 110 deletes an item corresponding to the touch input from the touch screen display 190. Additionally, the controller 110 may entirely or partially delete item related data stored in the storing unit 175. Further, the controller 110 may move the deleted item to a trash folder, and then completely delete the item from the storing unit 175 in response to a user's Empty Trash command, or re-display the item on the touch screen display 190, from the trash folder, in response to a user's Restore Trash command.

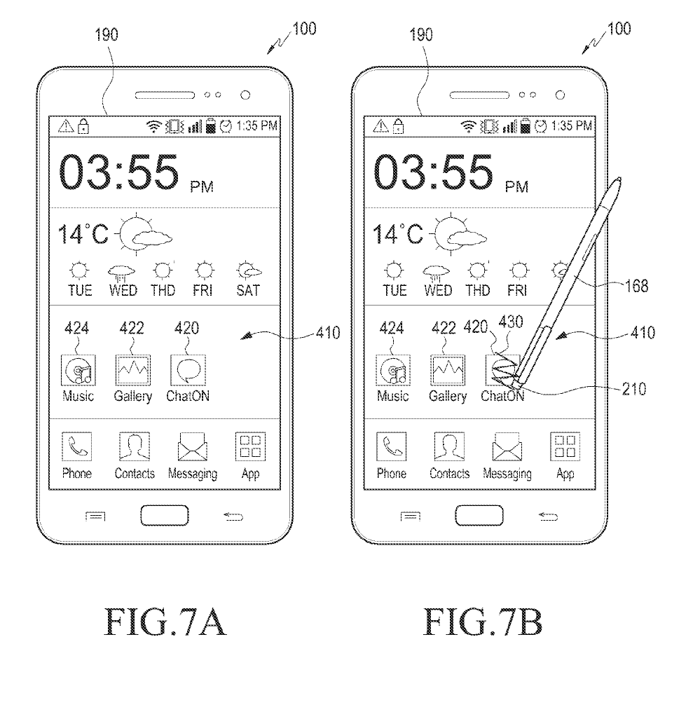

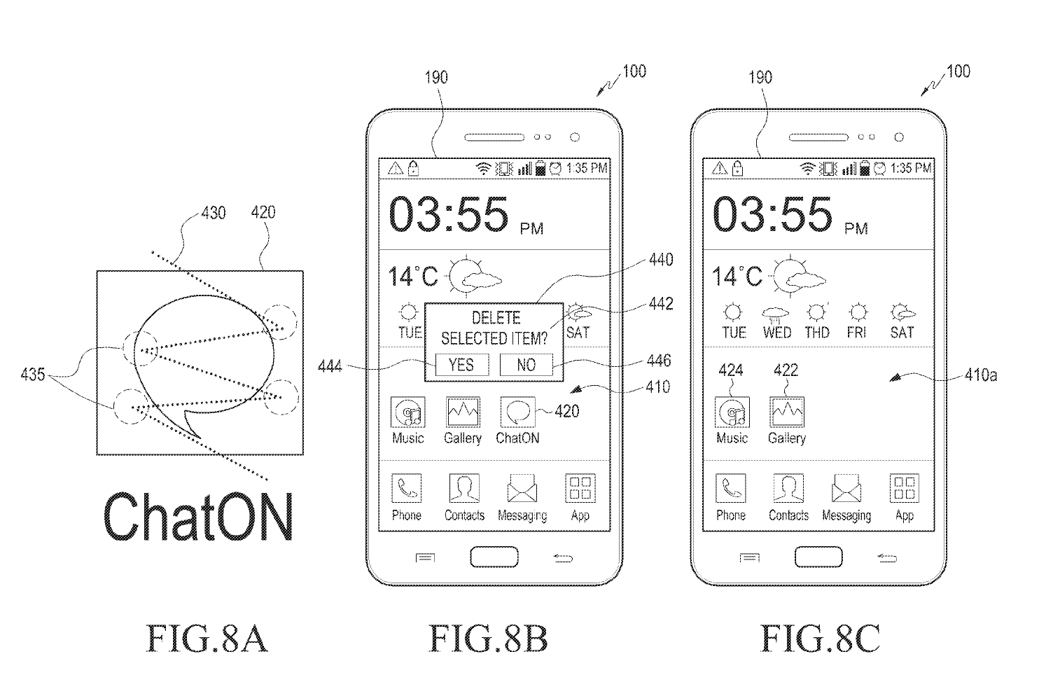

FIGS. 7A through 8C illustrate a method for deleting an item according to an embodiment of the present invention.

Referring to FIG. 7A, a music item 424 indicating a music application, a gallery item 422 indicating a gallery application, and a chat item 420 indicating a chat application are displayed on a home screen 410 of the touch screen display 190 of the portable terminal 100. The user executes the chat application related (or mapped) to the chat item 420 by touching the chat item 420 with the input tool 168 or a finger.

Referring to FIG. 7B, the user performs a drag touch in a zigzag form on the chat item 420 with the eraser 210 of the input tool 168 to delete the chat item 420.

FIG. 8A enlarges the chat item 420 in which a pattern of the drag touch (or a drag pattern) 430, i.e., the drag trajectory, is displayed with a dotted line on the chat item 420. The drag pattern 430 has four inflections 435. The inflections 435 are generated when the user drags in one direction and then drags in the other direction opposite to the one direction. The controller 110 compares the number of inflections 435 of the drag pattern 430 (in this example, 4) with a preset threshold (for example, 2). If the number of inflections 435 is greater than or equal to the preset threshold, then the controller 110 determines that the drag pattern 430 satisfies the first deletion condition.

Referring to FIG. 8B, the controller 110 displays a message window 440 on the touch screen display 190. The displayed message window 440 includes a guide phrase 442 “Delete Selected Item?”, an approve button 444 displayed with “Yes” to approve deletion of the item, and a cancel button 446 displayed with “No” to cancel deletion of the item. Alternatively, the message window 440 may further include a check box for deleting item related data, and a separate message window for deleting the item related data may then be displayed on the touch screen display 190.

Referring to FIG. 8C, if the user touches the OK button 444, the controller 110 determines that the second deletion condition is satisfied, and deletes the selected item 420, as illustrated on home screen 410a. If the user touches the cancel button 446, the controller 110 determines that the second deletion condition is not satisfied and cancels deletion of the selected item 420.

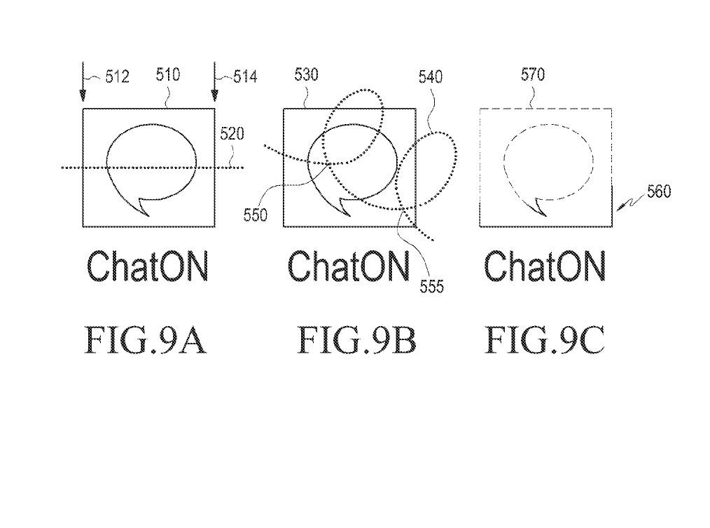

FIGS. 9A through 9C illustrate examples of different first deletion conditions according to embodiments of the present invention.

Referring to FIG. 9A, the user performs a drag touch by traversing a chat item 510 with the eraser 210 of the input tool 168 to delete the chat item 510. The controller 110 recognizes that a drag pattern 520 traverses the chat item 510 and determines that the drag pattern 520 satisfies the first deletion condition. For example, the controller 110 determines whether the drag pattern 520 passes through a first leader line 512 and a second leader line 514 that are set in the chat item 510. If the drag pattern 520 passes through the first leader line 512 and the second leader line 514, the controller 110 determines that the drag pattern 520 satisfies the first deletion condition.

Referring to FIG. 9B, the user performs a drag touch by making at least one intersections on a chat item 530 with the eraser 210 of the input tool 168 to delete the chat item 530. A drag pattern 540 has two intersections 550 and 555. The controller 110 compares the number of intersections 550 and 555 of the drag pattern 540 (in this example, 2) with a preset threshold (for example, 1). If the number of intersections 550 and 555 is greater than or equal to the preset threshold, the controller 110 determines that the drag pattern 540 satisfies the first deletion condition.

Referring to FIG. 9C, the user performs a drag touch by rubbing a chat item 560 with the eraser 210 of the input tool 168 to delete the chat item 560. In this case, a part 570 of the chat item 560 erased by the eraser 210 is displayed with a dotted line. The controller 110 compares a ratio of an area of the erased part 570 of the chat item 560 to a total area of the chat item 560 with a preset threshold (for example, ⅓). If the ratio is greater than or equal to the threshold, the controller 110 determines that the drag pattern 540 satisfies the first deletion condition.

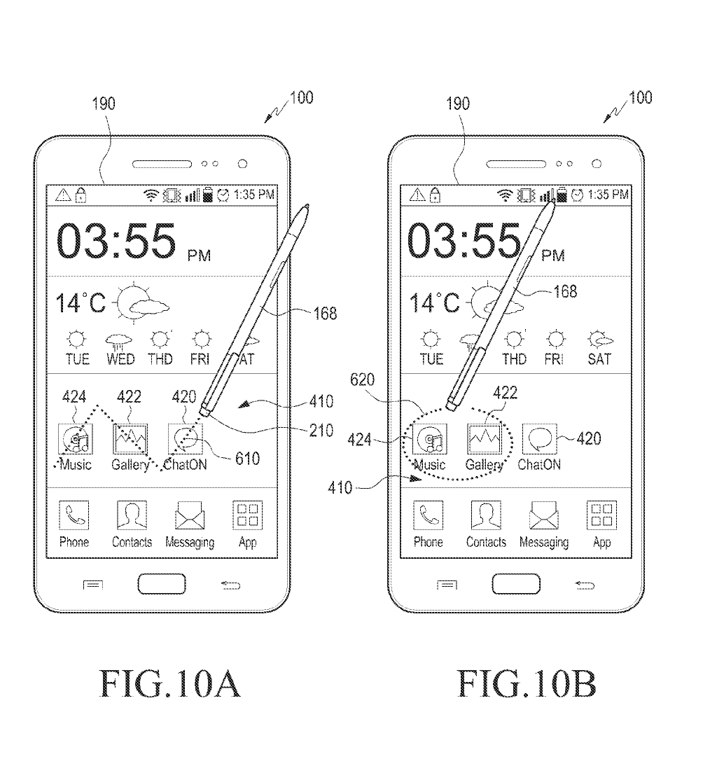

FIGS. 10A and 10B illustrate example of different methods for deleting a plurality of items at the same time according to embodiments of the present invention.

Referring to FIG. 10A, the user performs a drag touch by traversing the music item 424, the gallery item 422, and the chat item 420 with the eraser 210 of the input tool 168 to simultaneously delete the music item 424, the gallery item 422, and the chat item 420. The controller 110 recognizes that a drag pattern 610 traverses the music item 424, the gallery item 422, and the chat item 420 and determines that the drag pattern 610 satisfies the first deletion condition.

Referring to FIG. 10B, the user performs a drag touch by enclosing the music item 424 and the gallery item 422 with the eraser 210 of the input tool 168 to simultaneously delete the music item 424 and the gallery item 422. The controller 110 recognizes that a drag pattern 620 encloses the music item 424 and the gallery item 422 and determines that the drag pattern 620 satisfies the first deletion condition.

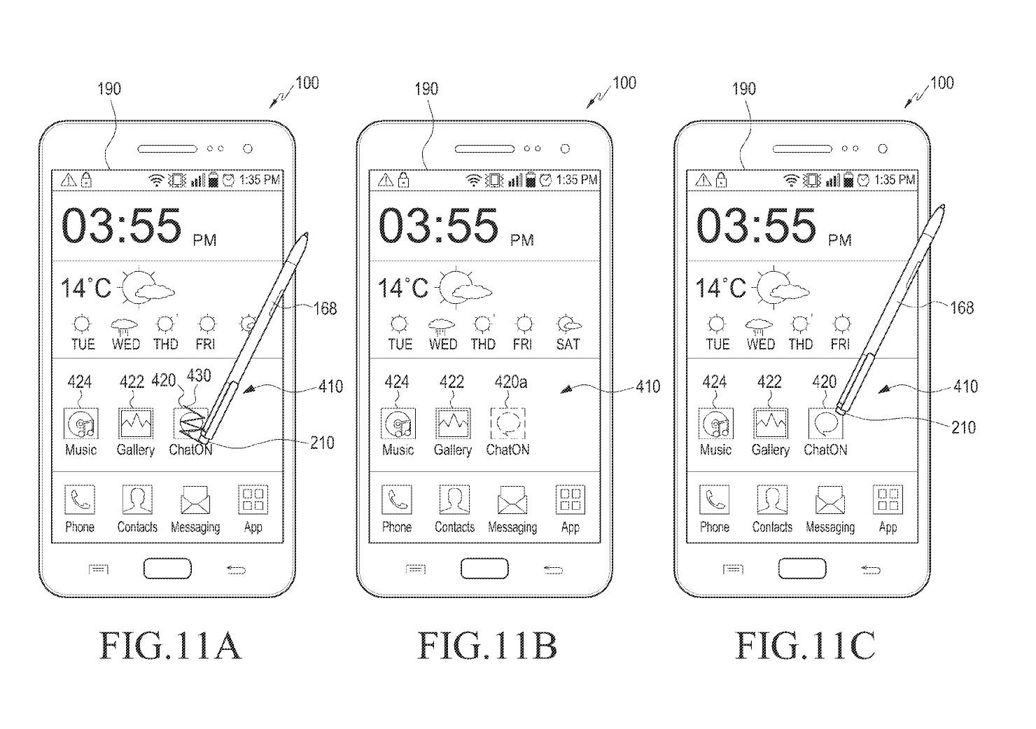

FIGS. 11A through 11C illustrate a method for deleting an item according to an embodiment of the present invention.

Referring to FIG. 11A, the user performs a drag touch in a zigzag form on the chat item 420 with the eraser 210 of the input tool 168 to delete the chat item 420. The controller 110 compares the number of inflections (in this example, 4) of the drag pattern 430 with a preset threshold (for example, 2), and determines that the drag pattern 430 satisfies the first deletion condition because the number of inflections is greater than or equal to the threshold.

Referring to FIG. 11B, when the user removes the eraser 210 from the touch screen display 190, the controller 110 operates a timer having a preset expiration time period and provides a preset visual effect to the chat item 420a during the expiration time period to show the progress of deletion of the selected item to the user.

Although FIG. 11B illustrates the visual effect for the chat item 420a as a dotted line, the visual effect may be one of an effect in which the chat item 420a gradually becomes dimmer, an effect in which the chat item 420a flickers, an effect in which the chat item 420a is gradually erased, an effect in which the remaining time of the timer is displayed, an effect in which the chat item 420a gradually becomes smaller, etc., or a combination thereof.

Referring to FIG. 11C, when the user touches the touch screen display 190 or the chat item 420 with the eraser 210 within the expiration time period after the end of the drag touch, deletion of the chat item 420 is canceled. The controller 110 counts the remaining time of the timer from the expiration of the timer, applies the visual effect to the chat item 420a until the remaining time is 0, and deletes the chat item 420a, if the deletion cancellation command is not input from the user during the expiration time period.

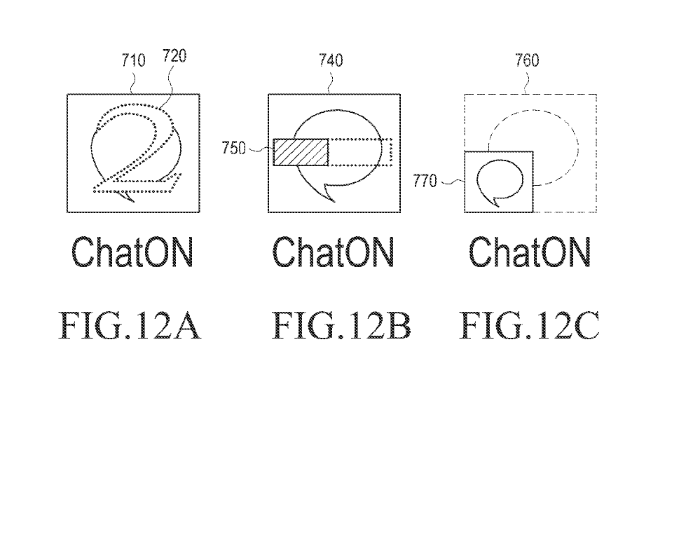

FIGS. 12A through 12C illustrate examples of different visual effects that can be applied to a selected item according to embodiments of the present invention.

Referring to FIG. 12A, a remaining time 720 of a timer is displayed as a number on a chat item 710. The controller 110 counts down the remaining time of the timer from the expiration of the timer, by updating and displaying the remaining time until it is 0 (for example, in the order of 3, 2, 1), and deletes the chat item 710 when the remaining time is 0.

Referring to FIG. 12B, the remaining time of the timer is displayed as a state bar 750 on the chat item 740. The controller 110 counts down the remaining time of the timer from the expiration of the timer, by updating and displaying the remaining time until it is 0 (for example, the length of the state bar 750 is gradually reduced), and deletes the chat item 740 when the remaining time is 0.

Referring to FIG. 12C, the size of the chat item 760 is gradually reduced. In FIG. 12C, the size of the original chat item 760 is displayed with a dotted line, and a size-reduced chat item 770 is displayed with a solid line. The controller 110 counts down the remaining time of the timer from the expiration of the timer, by gradually reducing the size of the chat item 760 and displaying the size-reduced chat item 760 until the remaining time is 0, and deletes the chat item 760 when the remaining time is 0.

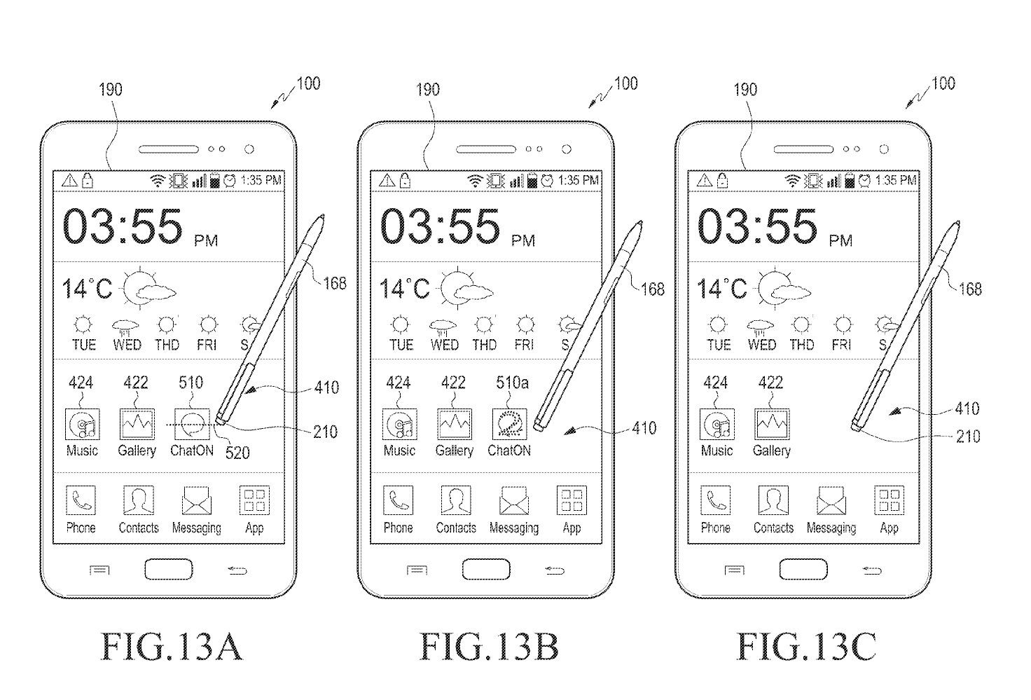

FIGS. 13A through 13C illustrate a method for deleting an item according to an embodiment of the present invention.

Referring to FIG. 13A, the user performs a drag touch by traversing a chat item 510 with the eraser 210 of the input tool 168 to delete the chat item 510. The controller 110 recognizes that the drag pattern 520 traverses the chat item 510 and determines that the drag pattern 520 satisfies the first deletion condition.

Referring to FIG. 13B, when the drag touch is ended, the controller 110 operates the timer having the preset expiration time period and provides a preset visual effect to a chat item 510a during the preset expiration time period to show the progress of the deletion of the selected chat item 510a to the user. In this example, the remaining time of the timer is displayed as a number on the chat item 510a.

Referring to FIG. 13C, the controller 110 counts the remaining time of the timer from the expiration of the timer, applies the visual effect to the chat item 510a until the remaining time is 0, and deletes the chat item 510 when no deletion cancellation command is input from the user within the expiration time period. That is, if the user continuously touches the touch screen display 190 or the chat item 510 with the eraser 210 during the expiration time period after the end of the drag touch, the controller 110 deletes the chat item 510. If the user removes the eraser 210 from the touch screen display 190 or the chat item 510, the controller 110 cancels deletion of the chat item 510.

The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an Application Specific Integrated Circuit (ASIC) or a Field Programmable Gate Array (FPGA). As would be understood in the art, the computer, the processor, microprocessor controller or the programmable hardware include memory components, for example, RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitutes hardware in the claimed invention. Under the broadest reasonable interpretation, the appended claims constitute statutory subject matter in compliance with 35 U.S.C. §101 and none of the elements consist of software per se.

The terms “unit” or “module” as may be used herein is to be understood as constituting hardware such as a processor or microprocessor configured for a certain desired functionality in accordance with statutory subject matter under 35 U.S.C. §101 and does not constitute software per se.

Additionally, the portable terminal 100 may receive and store a program including machine executable code that is loaded into hardware such as a processor and executed to configure the hardware, and the machine executable code may be provided from an external device connected in a wired or wireless manner. The device providing the machine executable code can include a non-transitory memory for storing the machine executable code that when executed by a processor will instruct the portable terminal to execute a preset method for deleting an item displayed on a touch screen, information necessary for the method for deleting an item displayed on the touch screen, etc., a communication unit for performing wired or wireless communication with the host, and a controller for transmitting a corresponding program to the host at the request of the host device or automatically.

While the present invention has been particularly shown and described with reference to certain embodiments thereof, various changes in form and detail may be made therein without departing from the spirit and scope of the present invention as defined by the following claims and any equivalents thereto.

What is claimed is:

1. A method for deleting an item displayed on a touch screen display, the method comprising:
recognizing a drag touch on the item displayed on the touch screen display;
determining whether a pattern of the drag touch satisfies a first deletion condition;
determining whether a second deletion condition associated with a user input on the touch screen display is satisfied, if the first deletion condition is satisfied; and
deleting the item from the touch screen display, if the second deletion condition is satisfied.

2. The method of claim 1, wherein the first deletion condition comprises at least one of:
a condition that a drag trajectory indicating the pattern of the drag touch at least partially overlaps the item;
a condition that the drag trajectory encloses the item;
a condition that the drag trajectory has at least a preset number of inflections;
a condition that the drag trajectory has at least a preset number of intersections; and
a condition that the item is erased at least a preset rate.

3. The method of claim 1, wherein the second deletion condition comprises at least one of:
a condition that no deletion cancellation command is input from a user for a preset time, after an end of the drag touch; and
a condition that the user approves deletion of the item, after the end of the drag touch.

4. The method of claim 1, further comprising displaying a message window requesting a user to approve or cancel deletion of the item on the touch screen display.

5. The method of claim 1, further comprising applying a visual effect to the item, if the first deletion condition is satisfied.

6. The method of claim 1, wherein the visual effect comprises at least one of:
an effect in which the item gradually dims;
an effect in which the item flickers;
an effect in which the item is gradually erased;
an effect in which a remaining time of a timer is displayed; and
an effect in which the item gradually shrinks.

7. The method of claim 1, further comprising:
operating a timer having an expiration time period, if the first deletion condition is satisfied; and
canceling deletion of the item, if a second touch on the item is generated during the expiration time period.

8. The method of claim 1, further comprising:
operating a timer having an expiration time period, if the first deletion condition is satisfied; and
canceling deletion of the item, if the drag touch is removed from the touch screen during the expiration time period.

9. The method of claim 1, wherein recognizing the drag touch on the item displayed on the touch screen display comprises identifying the drag touch being performed by an eraser end of an input tool.

10. The method of claim 1, further comprising canceling deletion of the item, if one of the first deletion condition and the second deletion condition is not satisfied.

11. A non-transitory machine-readable storage medium having recorded thereon a program for executing a method for deleting an item displayed on a touch screen display, the method comprising:
recognizing a drag touch on the item displayed on the touch screen display;
determining whether a pattern of the drag touch satisfies a first deletion condition;
determining whether a second deletion condition associated with a user input on the touch screen display is satisfied, if the first deletion condition is satisfied; and
deleting the item from the touch screen display, if the second deletion condition is satisfied.

12. A portable terminal comprising:
a touch screen display configured to display an item;
a storing unit configured to store a first deletion condition and a second deletion condition; and
a controller configured to recognize a drag touch on the item displayed on the touch screen display, to determine whether a pattern of the drag touch satisfies the first deletion condition, to determine whether the second deletion condition associated with a user input on the touch screen display is satisfied, if the first deletion condition is satisfied, and to delete the item from the touch screen display, if the second deletion condition is satisfied.

13. The portable terminal of claim 12, wherein the first deletion condition comprises at least one of:
a condition that a drag trajectory indicating the pattern of the drag touch at least partially overlaps the item;
a condition that the drag trajectory encloses the item;
a condition that the drag trajectory has at least a preset number of inflections;
a condition that the drag trajectory has at least a preset number of intersections; and
a condition that the item is erased at least a preset rate.

14. The portable terminal of claim 12, wherein the second deletion condition comprises at least one of:
a condition that no deletion cancellation command is input from a user for a preset time, after an end of the drag touch; and
a condition that the user approves deletion of the item, after the end of the drag touch.

15. The portable terminal of claim 12, wherein the controller is configured to apply a visual effect to the item, if the first deletion condition is satisfied.

16. The portable terminal of claim 12, wherein the controller is configured to cancel deletion of the item, if one of the first deletion condition and the second deletion condition is not satisfied.
